(19) United States
(12) Patent Application Publication
(10) Pub. No.: US 2010/0045798 A1
(43) Pub. Date: Feb. 25, 2010

(54) ELECTRONIC CAMERA

(75) Inventors: Hiroshi Sugimoto, Osaka (JP); Takanori Sato, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/540,838

(22) Filed: Aug. 13, 2009

(30) Foreign Application Priority Data
Aug. 21, 2008 (JP) 2008-212407

(51) Int. Cl. H04N 5/228; H04N 7/18

(52) U.S. Cl. 348/157; 348/222.1; 348/E05.024

(57) ABSTRACT

An electronic camera includes an imaging device. The imaging device has an imaging surface on which an object scene is captured and repeatedly outputs an object scene image. To the object scene, a plurality of evaluation groups are allocated. Moreover, each of the plurality of evaluation groups is formed by a plurality of evaluation areas. A CPU calculates an evaluation coefficient representing a motion of an object in each of the plurality of evaluation areas, based on the object scene image outputted from the imaging device. The CPU also specifies one of more evaluation groups to which an evaluation area corresponding to an evaluation coefficient exceeding a reference value belongs, and compares a pattern of the specified evaluation groups with a plurality of predetermined patterns. An imaging parameter is adjusted based on a comparison result.

### CROSS REFERENCE OF RELATED APPLICATION

The disclosure of Japanese Patent Application No. 2008-212407, which was filed on Aug. 21, 2008 is incorporated herein by reference.

### BACKGROUND OF THE INVENTION

1. Field of the Invention

The present invention relates to an electronic camera. More particularly, the present invention relates to an electronic camera for adjusting an imaging parameter in a manner to match an object scene.

2. Description of the Related Art

According to one example of this type of electronic camera, a proportion of a subject in which a motion amount exceeds a threshold value to a central region of an object scene and a proportion of the subject in which the motion amount exceeds the threshold value to a surrounding region of the object scene are individually detected by a CPU. When a difference between the respective detected proportions is large, the CPU adjusts a photographing parameter in a manner to match a sport scene.

However, in the above-described electronic camera, a region to be noticed for detecting the proportion is fixedly allocated, for example, fixed to the central region and the surrounding region. Therefore, there is a limit to a capability of determining the sport scene, by extension, a capability of adjusting the imaging parameter.

### SUMMARY OF THE INVENTION

An electronic camera according to the present invention comprises: an imager, having an imaging surface on which an object scene is captured, for repeatedly outputting an object scene image; a detector for detecting one or more motion areas indicating motion exceeding a reference from among a plurality of areas on the object scene, based on the object scene image outputted from the imager; and an adjuster for adjusting an imaging parameter by comparing a pattern of the one or more motion areas detected by the detector with a predetermined area pattern.

Preferably, each of the plurality of areas has a plurality of small areas, and the detector includes a motion coefficient calculator for calculating a plurality of motion coefficients respectively corresponding to the plurality of small areas, an extractor for extracting a motion coefficient exceeding a reference value from among the plurality of motion coefficients calculated by the motion coefficient calculator, and a specifier for specifying, as the motion area, an area to which the small area corresponding to the motion coefficient extracted by the extractor belongs.

Preferably, the detector repeatedly executes a detecting process, and the adjuster includes a creator for repeatedly creating a pattern of the one of more motion areas and a setter for setting the imaging parameter to a predetermined parameter in reference to a number of times that satisfies a predetermined condition between the pattern created by the creator and the predetermined area pattern.

Preferably, the predetermined condition includes a condition under which the predetermined area pattern involves the pattern created by the creator.

Preferably, the imaging parameter adjusted by the adjuster is equivalent to an imaging parameter that matches a sport scene.

According to the present invention, an imaging controlling program product executed by a processor of an electronic camera provided with an imager, having an imaging surface on which an object scene is captured, for repeatedly outputting an object scene image, the imaging controlling program product, comprises: a detecting step of detecting a motion area indicating motion exceeding a reference from among a plurality of areas on the object scene, based on the object scene image outputted from the imager, and an adjusting step of adjusting an imaging parameter by comparing a pattern for the motion area detected by the detecting step with a predetermined area pattern.

According to the present invention, an imaging controlling method executed by an electronic camera provided with an imager, having an imaging surface on which an object scene is captured for repeatedly outputting an object scene image, the imaging controlling method, comprises: a detecting step of detecting one or more motion areas indicating motion exceeding a reference from among a plurality of areas on the object scene, based on the object scene image outputted from the imager; and an adjusting step of adjusting an imaging parameter by comparing a pattern of the one or more motion areas detected by the detecting step with a predetermined area pattern.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of an allocation state of an evaluation area on an imaging surface;

FIG. 3 is an illustrative view showing one example of a distributed state of variables CNT_{—}0 to CNT_{—}15 applied to the embodiment in FIG. 1;

FIG. 4(A) is an illustrative view showing one example of a predetermined motion pattern DP_{—}0;

FIG. 4(B) is an illustrative view showing one example of a predetermined motion pattern DP_{—}1;

FIG. 4(C) is an illustrative view showing one example of a predetermined motion pattern DP_{—}2;

FIG. 4(D) is an illustrative view showing one example of a predetermined motion pattern DP_{—}3;

FIG. 4(E) is an illustrative view showing one example of a predetermined motion pattern DP_{—}4;

FIG. 4(F) is an illustrative view showing one example of a predetermined motion pattern DP_{—}5;

FIG. 4(G) is an illustrative view showing one example of a predetermined motion pattern DP_{—}6;

FIG. 5 is an illustrative view showing one example of an object scene;

FIG. 6 is an illustrative view showing one portion of an operation of the embodiment in FIG. 1;

FIG. 7 is a flowchart showing one portion of an operation of a CPU applied to the embodiment in FIG. 1;

FIG. 8 is a flowchart showing another portion of the operation of the CPU applied to the embodiment in FIG. 1;

FIG. 9 is a flowchart showing still another portion of the operation of the CPU applied to the embodiment in FIG. 1;

FIG. 10 is a flowchart showing yet still another portion of the operation of the CPU applied to the embodiment in FIG. 1;

FIG. 11 is a flowchart showing another portion of the operation of the CPU applied to the embodiment in FIG. 1; and

FIG. 12 is a flowchart showing still another portion of the operation of the CPU applied to the embodiment in FIG. 1.

### DETAILED DESCRIPTION OF THE PREFERRED EMBODIMENTS

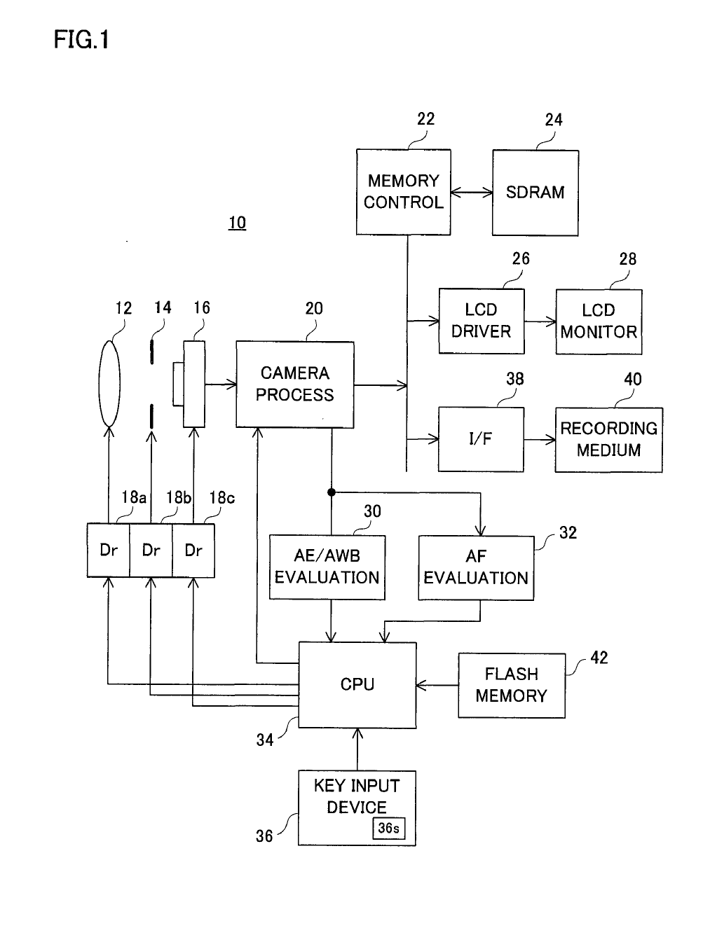

With reference to FIG. 1, a digital camera 10 according to this embodiment includes a focus lens 12 and an aperture unit 14 respectively driven by drivers 18a and 18b. An optical image of an object scene that undergoes these components is irradiated onto an imaging surface of an imaging device 16, and subjected to photoelectric conversion. Thereby, electric charges representing the object scene image are produced.

It is noted that the imaging surface is covered with a primary color filter not shown, and the electric charges produced by each of a plurality of pixels placed on the imaging surface have color information of any one of R (Red), G (Green), and B (Blue).

When power is inputted in order to execute a through image process under an imaging task, a CPU 34 commands a driver 18c to repeat an exposure operation and a thinning-out reading-out operation. The driver 18c, in response to a vertical synchronization signal Vsync periodically generated from an SG (Signal Generator) not shown, exposes the imaging surface and reads out one portion of the electric charges produced on the imaging surface in a raster scanning manner. From the imaging device 16, raw image data based on the read-out electric charges are periodically outputted.

A camera processing circuit 20 performs processes, such as a white balance adjustment, a color separation, and a YUV conversion, on the raw image data outputted from the imaging device 16, so as to produce image data of a YUV format. The produced image data is written into an SDRAM 24 through a memory control circuit 22. An LCD driver 26 repeatedly reads out the image data accommodated in the SDRAM 24 through the memory control circuit 22, and drives an LCD monitor 28 based on the readout image data As a result, a real-time moving image (through image) of the object scene is displayed on a monitor screen.

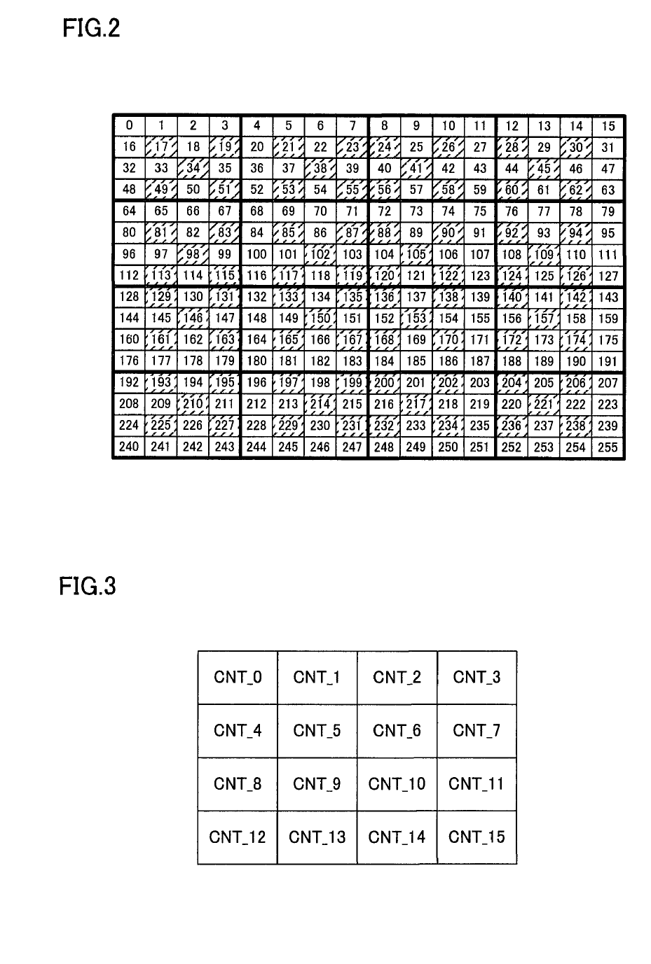

With reference to FIG. 2, the imaging surface is divided into 16 portions in each of a horizontal direction and a vertical direction, and thus, a total of 256 evaluation areas are allocated on the imaging surface.

An AE/AWB evaluating circuit 30 integrates one portion of Y data belonging to each evaluation area, out of Y data outputted from the camera processing circuit 20, at each generation of the vertical synchronization signal Vsync. Thereby, 256 integral values, i.e., 256 AE/AWB evaluation values, are outputted from the AE/AWB evaluating circuit 30 in response to the vertical synchronization signal Vsync.

An AF evaluating circuit 32 integrates a high frequency component of one portion of Y data belonging to each evaluation area at each generation of the vertical synchronization signal Vsync. Thereby, 256 integral values, i.e., 256 AF evaluation values are outputted from the AF evaluating circuit 32 in response to the vertical synchronization signal Vsync.

Before a shutter button 36s arranged in a key input device 36 is manipulated, an imaging mode is set to a normal mode. The CPU 34 executes a through image-use AE/AWB process that matches the normal mode based on the AE/AWB evaluation values outputted from the AE/AWB evaluating circuit 30, and calculates an appropriate aperture amount, an appropriate exposure time period, and an appropriate white balance adjusting gain that match the normal mode, as an appropriate imaging parameter. The calculated appropriate aperture amount, appropriate exposure time period, and appropriate white balance adjusting gain are set to the drivers 18b, 18c, and the camera processing circuit 20, respectively. As a result, a brightness and a white balance of the through image displayed on the LCD monitor 28 are moderately adjusted.

When the shutter button 36s is half-depressed, the CPU 34 executes a mode setting process so as to select an imaging mode according to the object scene, and thereafter, executes an AF process based on the AF evaluation values outputted from the AF evaluating circuit 32 and a recording-use AE process based on the AE/AWB evaluation values outputted from the AE/AWB evaluating circuit 30.

The AF process is executed based on the AF evaluation values outputted from the AF evaluating circuit 32. The focus lens 12 is moved in an optical-axis direction by the driver 18a, and is placed at a focal point by a so-called hill-climbing process.

The recording-use AE process is executed in a manner that matches the selected imaging mode. Thereby, an optimal aperture amount and an optimal exposure time period are calculated as an optimal imaging parameter of a current imaging mode. The calculated optimal aperture amount and optimal exposure lime period are respectively set to the drivers 18b and 18c, similarly to the above-described case. As a result, the brightness of the through image displayed on the LCD monitor 30 is adjusted to an optimal value.

When the shutter button 36s is fully depressed, the recording-use AWB process is executed in a manner that matches the selected imaging mode. Thereby, an optimal white balance adjusting gain is calculated as an optimal imaging parameter of the current imaging mode. The calculated optimal white balance adjusting gain is set to the camera processing circuit 20, similarly to the above-described case. As a result, the white balance of the through image displayed on the LCD monitor 30 is adjusted to an optimal value.

Upon completion of the recording-use AWB process, a recording process is executed. The CPU 34 commands the driver 18c to execute a main exposure operation and all-pixel reading-out, one time each. The driver 18c performs the main exposure on the imaging surface in response to the generation of the vertical synchronization signal Vsync, and reads out all the electric charges produced on the imaging surface in a raster scanning manner As a result, high-resolution raw image data representing the object scene is outputted from the imaging device 16.

The outputted raw image data is subjected to the process similarly as described above, and as a result, high-resolution image data according to a YUV format is secured in the SDRAM 24. An I/F 38 reads out the high-resolution image data thus accommodated in the SDRAM 24 through the memory control circuit 22, and then, records the read-out image data on a recording medium 40 in a file format. It is noted that the through-image process is resumed at a time point when the high-resolution image data is accommodated in the SDRAM 24. Also, the imaging mode is returned to the normal mode.

The mode setting process is executed as follows: Firstly, the 256 evaluation areas allocated on the imaging surface are divided into 16 evaluation groups in a manner that follows bold lines shown in FIG. 2. Therefore, each evaluation group is formed by 16 evaluation areas. Also, according to FIG. 2, five evaluation areas, out of the 16 evaluation areas belonging to each evaluation group, are hatched. The evaluation areas indicated by hatching, i.e., hatching areas, are noticed at the time of calculating a motion coefficient described later.

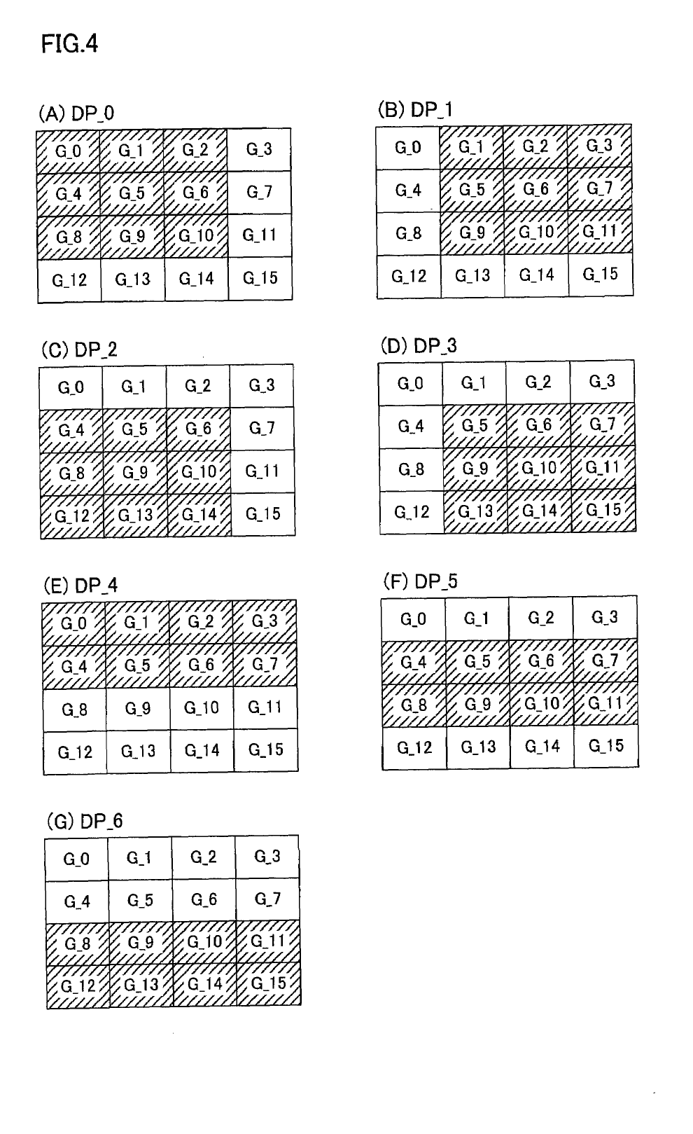

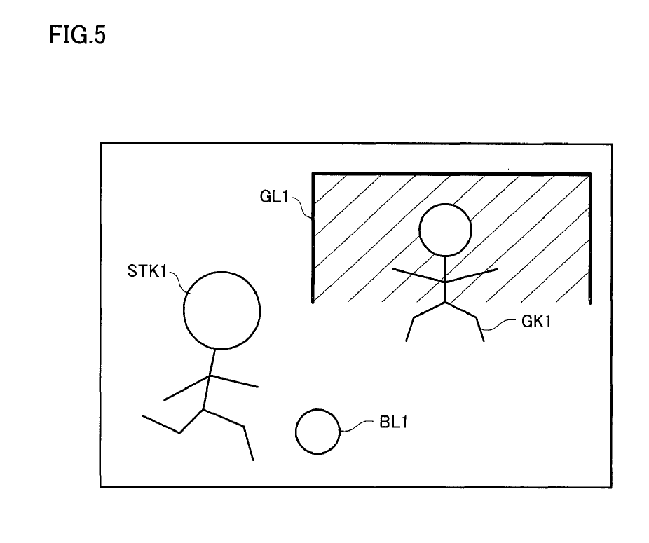

To the 16 divided evaluation groups, identification numbers G_{—}0 to G_{—}15 are allocated in a manner shown in FIG. 4(A) to FIG. 4(G). To the evaluation groups G_{—}0 to G15, variables CNT_{—}0 to CNT_{—}15 used for a motion detection are further allocated in a manner shown in FIG. 3.

When the vertical synchronizing signal Vsync is generated, based on the AE/AWB evaluation values acquired in the hatching area shown in FIG. 2, the motion coefficient is calculated. Upon calculation of the motion coefficient, Equation 1 is referenced.

EC(M, N)=ΔVL(M, N)*256/VLmax(M, N) [Equation 1]
M:0 to 15
N: 0 to 4
EC(M, N): a motion coefficient of an N-th hatching area belonging to the evaluation group G_{≦}M
ΔVL(M, N): a frame-to-frame difference of the AE/AWB evaluation values acquired in an N-th hatching area belonging to the evaluation group G_M
VLmax(M, N): a larger AE/AWB evaluation value, out of the two AE/AWB evaluation values referenced for the calculation of ΔVL(M, N)

The calculated motion coefficient EC(M, N) is compared with a reference value REF, and when the motion coefficient EC(M, N) exceeds the reference value REF, a variable CNT_M is incremented. That is, the incremented variable is equivalent to a variable allocated to the evaluation group including the hatching area in which a motion coefficient exceeding the reference value REF is obtained.

Upon completion of the above-described operation for the 80 hatching areas shown in FIG. 2, values of the variables CNT_{—}0 to CNT_{—}15 in an object scene image of a current frame are finalized. A motion pattern of an object present in the object scene is created with reference to the finalized variables CNT_{—}0 to CNT_{—}15. Specifically, out of the variables CNT_{—}0 to CNT_{—}15, a variable indicating a numerical value equal to or more than “1” is extracted, and an evaluation group to which the extracted variable is allocated is specified as a motion group. Then, a pattern formed by the specified motion group is created as a motion pattern MP.

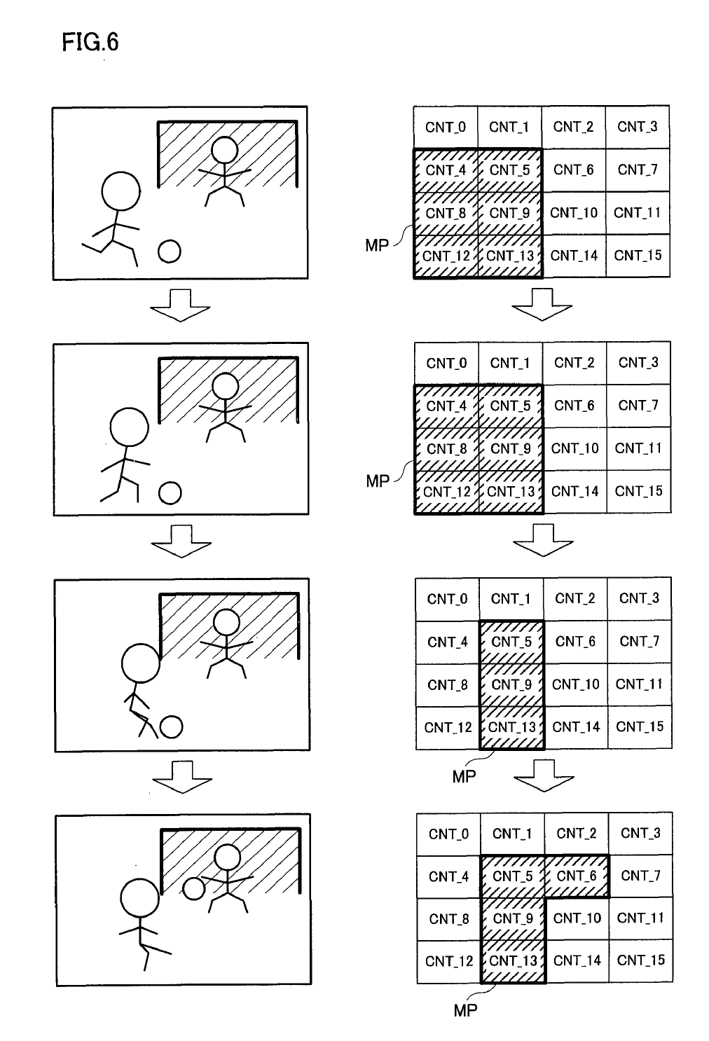

Therefore, as shown in FIG. 5, in a case of capturing a sport scene including a goal keeper GK1, a striker STK1, a goal GL1, and a ball BL1, when a background of the variable CNT_M indicating a numerical value equal to or more than “1” is hatched, the motion pattern MP changes in a manner shown in a right column of FIG. 6 along with motion of the striker STRK1 and/or the ball BL1 shown in a left column of FIG. 6.

When the number of evaluation groups forming the motion pattern MP is equal to or more than “3” and equal to or less tan “9”, a matching process for determining whether or not the motion pattern MP satisfies a sport scene condition is executed, regarding that a dynamic object is present in the object scene. Specifically, it is determined whether or not the evaluation group forming the motion pattern MP is involved by an evaluation group forming any one of predetermined motion patterns DP_{—}0 to DP_{—}6 shown in FIG. 4(A) to FIG. 4(G). When a determination result is affirmative, a variable K is incremented, regarding that the motion pattern MP satisfies the sport scene condition. When the determination result is negative, the increment of the variable K is canceled, regarding that the motion pattern MP does not satisfy the sport scene condition.

On the other hand, when the number of evaluation groups forming the motion pattern MP falls below “3” or exceeds “9”, the variable K is decremented in a range where “0” is a lowest value, regarding that the dynamic object is not present in the object scene.

Between a motion pattern MP at a topmost level or a second level in the right column in FIG. 6, and the the predetermined motion pattern DP_{—}2 shown in FIG. 4(C), the sport scene condition is satisfied. Moreover, between a motion patterns MP at a third level in the right column in FIG. 6 and the predetermined motion pattern DP_{—}2 shown in FIG. 4(C) or the predetermined motion pattern DP_{—}3 shown in FIG. 4(D), the sport scene condition is satisfied. Furthermore, between a motion patterns MP at a lowest level in the right column in FIG. 6 and the predetermined motion pattern DP_{—}3 shown in FIG. 4(D), the sport scene condition is satisfied. Therefore, when a motion as shown in FIG. 6 occurs, the variable K is increased to “4”.

When the updated variable K reaches “4”, it is determined that the object scene is equivalent to the sport scene. As a result, the imaging mode is finalized to the sport mode. Also, unless the variable K reaches “4”, another scene determining&mode finalizing process is executed in parallel. It is noted that in this case, the imaging mode may be fed to a mode different from the sport mode. However, when the scene is not explicitly determined even after an elapse of a 30-frame period from a start of the mode setting process, the imaging mode is finalized to the normal mode. The above-described recording-use AE/AWB process is executed in a manner that matches the imaging mode thus finalized.

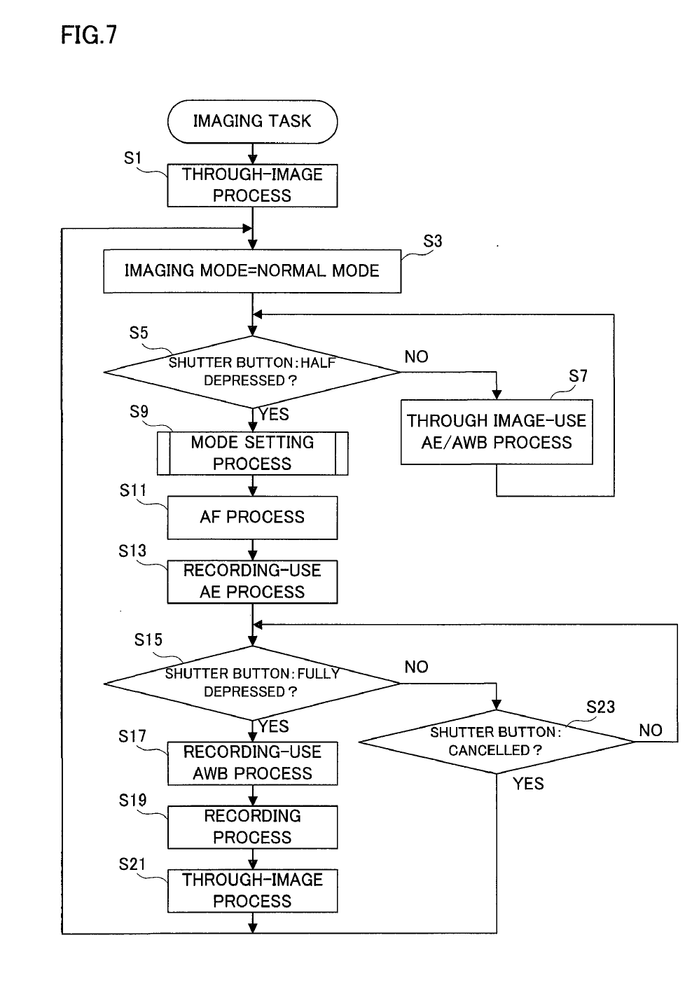

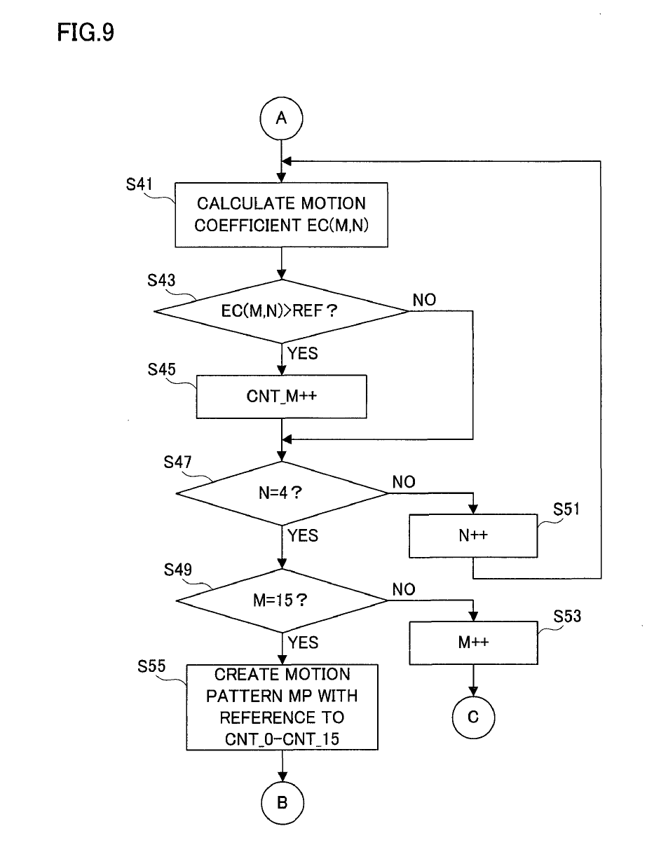

The CPU 34 executes in parallel a plurality of tasks, including an imaging task shown in FIG. 7 to FIG. 12. It is noted that control programs corresponding to these tasks are stored in a flash memory 42.

With reference to FIG. 7, the through-image process is executed in a step S1, and in a subsequent step S3, the imaging mode is set to the normal mode. As a result of the process in the step S1, the through image that represents the object scene is outputted from the LCD monitor 38.

In a step S5, it is determined whether or not the shutter button 36s is half-depressed, and as long as the determination result indicates NO, the through image-use AE/AWB process in a step S7 is repeated. As a result, the brightness and the white balance of the through image are moderately adjusted in a manner according to the normal mode.

When the shutter button 36s is half-depressed, the mode setting process is executed in a step S9 in order to select an imaging mode that matches the object scene. In a step S11, the AF process is executed, and in a step S13, the recording-use AE process is executed. As a result of the process in the step S11, the focus lens 12 is placed at the focal point. The recording-use AE process in the step S13 is executed in a manner that matches the selected imaging mode.

In a step S15, it is determined whether or not the shutter button 36s is fully depressed, and in a step S23, it is determined whether or not a manipulation of the shutter button 36s is cancelled. When YES is determined in the step S15, the process proceeds to a step S17 in which the recording-use AWB process is executed in a manner that matches the selected imaging mode. Upon completion of the recording-use AWB process, the process undergoes a recording process in a step S19 and a through image process in a step S21, and then, returns to the step S3. When YES is determined in the step S23, the process returns to the step S3 as it is.

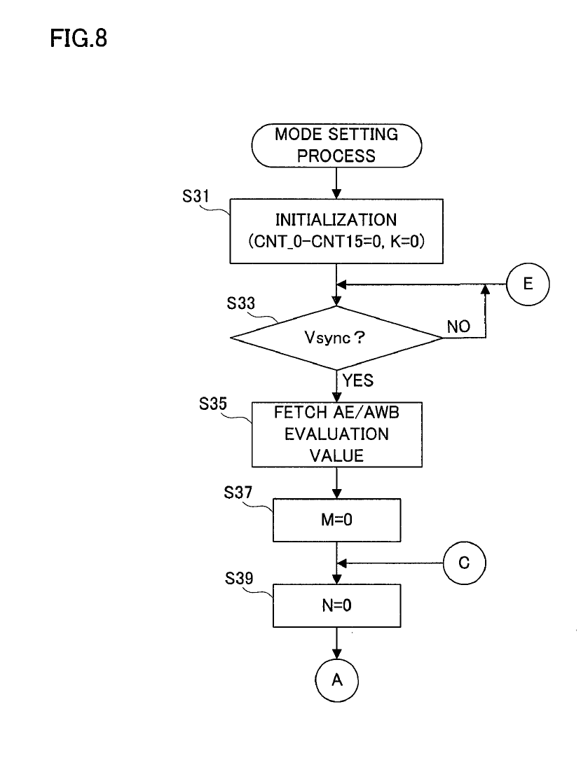

The mode setting process in the step S9 is executed according to a subroutine shown in FIG. 8 to FIG. 12. Firstly, in a step S31, an initializing process is performed. As a result, the variables CNT_{—}0 to CNT_{—}15 are set to “0”, and furthermore, the variable K is set to “0”. In a step S33, it is determined whether or not the vertical synchronizing signal Vsync is generated, and when YES is determined, the 256 AE/AWB evaluation values are fetched from the AE/AWB evaluating circuit 30 in a step S35. Subsequently, in a step S37, the variable M is set to “0”, and in a step S39, the variable N is set to “0”.

In a step S41, according to the above-described Equation 1, the motion coefficient EC(M, N) is calculated, and in a step S43, it is determined whether or not the calculated motion coefficient EC(M, N) exceeds the reference value REF. Herein, when NO is determined, the process proceeds to a step S47 as it is while YES is determined, the process incrementing the variable CNT_M in a step S45, and then, proceeds to the step S47.

In the step S47, it is determined whether or not the variable N reaches “4”, and in a step S49, it is determined whether or not the variable M reaches “15”. When NO is determined in the step S47, the process increments the variable N in the step S51, and then, returns the step S41. When YES is determined in the step S47 while when NO is determined in the step S49, the process increments the variable M in a step S53, and then, returns to the step S39.

When YES is determined in both of the steps S47 and S49, the process proceeds to a step S55 in which the motion pattern MP is created with reference to the variables CNT_{—}0 to CNT_{—}15. Specifically, out of the variables CNT_{—}0 to CNT_{—}15, a variable showing a numerical value equal to or more than “1” is extracted, and an evaluation group corresponding to the extracted variable is specified as a motion group. Then, a pattern formed by the specified motion group is created as the motion pattern MP.

In a step S57, it is determined whether or not the number of evaluation groups (=MG) forming the motion patter MP is equal to or more than “3” and equal to or less Man “9”. Herein, when NO is determined, the variable K is decremented in a range equal to or more than “0”, and then, the process proceeds to a step S71. On the other hand, when YES is determined, the process proceeds to a step S61 in which the matching process for determining whether or not the motion pattern MP created in the step S55 satisfies the sport scene condition is executed. A flag FLG_sprt is set to “1” when the motion pattern MP satisfies the sport scene condition while set to “0” when the motion pattern MP does not satisfy the sport scene condition.

In a step S63, it is determined whether or not the flag FLG_sprt indicates “1”. When NO is determined, the process proceeds to a step S71 while YES is determined, the variable K is incremented in a step S65. In a step S67, it is determined whether or not the variable K is equal to or more than “4”. When NO is determined, the process proceeds to a step S71 while YES is determined, the imaging mode is finalized to the sport mode in the step S69. Upon completion of the process in the step S69, the process is restored to a routine at a hierarchically upper level.

In a step S71, the another scene determining & mode finalizing process is executed. In a step S73, it is determined whether or not the imaging mode is finalized by the process in the step S71, and in a step S75, it is determined whether or not a 30-frame period has been elapsed from a start of the mode setting process. When YES is determined in the step S73, the process is restored to the routine at a hierarchically upper level as it is, and when YES is determined in the step S75, the process finalizes the imaging mode to the normal mode, and then, is restored to the routine at a hierarchically upper level. When NO is determined in both of the steps S73 and S75, the process returns to the step S33.

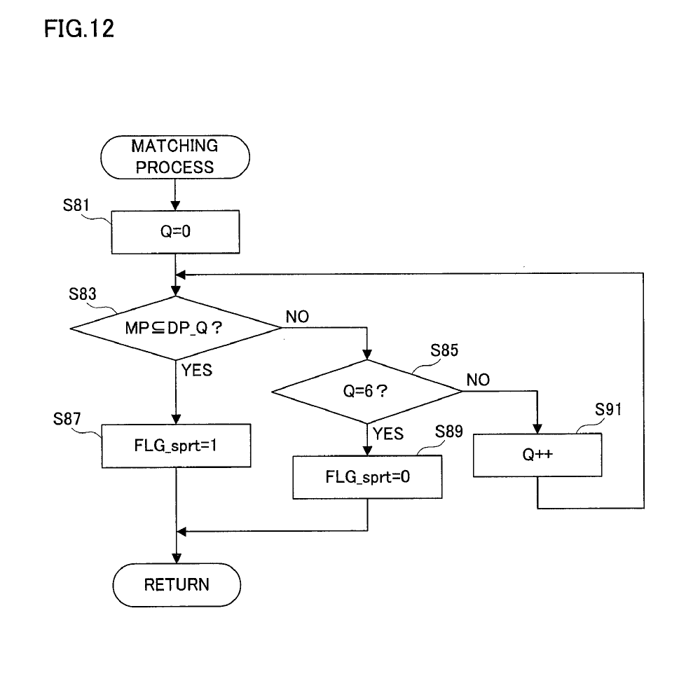

The matching process in the step S61 is executed according to a subroutine shown in FIG. 12. Firstly, in a step S81, the variable Q is set to “0”. In a step S83, it is determined whether or not the evaluation group forming the motion pattern MP is involved by the evaluation group forming the motion pattern DP_Q. When YES is determined in this step, it is regarded that the sport scene condition is satisfied, and thus, the flag FLG_sprt is set to “1” in a step S87, and then, the process is restored to the routine at a hierarchically upper level. On the other hand, when NO is determined, i.e., when the sport scene condition is not satisfied, it is determined in a step S85 whether or not the variable Q reaches “6”. When NO is determined in this step, the variable Q is incremented in a step S91, and then, the process returns to the step S85. When YES is determined, the flag FLG_sprt is set to “0” in a step S89, and then, the process is restored to the routine at a hierarchically upper level.

As understood from the above description, the imaging device 16 has an imaging surface for capturing an object scene, and repeatedly outputs the object scene image. The CPU 34 notices the evaluation areas B_{—}0 to B_{—}4 belonging to each of the evaluation groups G_{—}0 to G_{—}15 allocated on the object scene (S37 to S39 and S47 to S53) so as to calculate the motion coefficient in the noticed evaluation area based on the object scene image outputted from the imaging device 16 (S41). Also, the CPU 34 specifies the evaluation group including the evaluation area in which the motion coefficient exceeds the reference value REF, as a motion group indicating a motion exceeding the reference (S43 to S45). Moreover, the CPU 34 creates the pattern of one or more motion groups specified as the motion pattern MP (S55), and compares the created motion pattern MP with the predetermined motion patterns DP_{—}0 to DP_{—}6 so as to adjust the imaging parameter (S57 to S69, S13, and S17).

When a cause of the motion exceeding the reference is a camera shake on the imaging surface, all the evaluation groups G_{—}0 to G_{—}15 are detected as the motion group. On the other hand, when a cause of the motion exceeding the reference is a motion of an object present in the object scene, one portion of the evaluation groups G_{—}0 to G_{—}15 is detected as the motion group. Which of these causes, i.e., the camera shake on the imaging surface and the motion of an object, result in the motion is determined by comparing the pattern of the detected motion groups, i.e., the motion pattern MP, with the predetermined motion patterns DP_{—}0 to DP_{—}15. When this determination result is referenced, it becomes possible to adjust the imaging parameter according to the cause of the motion. Thus, the improvement in capability of adjusting the imaging parameter is implemented.

Moreover, the accuracy for detecting the motion of an object depends on the number of the evaluation areas allocated on the imaging surface. The larger the number of evaluation areas, the higher the detection accuracy. However, the increase in number of evaluation areas makes it difficult to comprehend the behavior of the motion of an object.

In this embodiment, evaluation areas allocated on the imaging surface are grouped and the pattern of the evaluation groups to which the evaluation area in which the motion occurs belongs is noticed. Thus, irrespective of an increase in number of evaluation areas allocated on the imaging surface, it becomes easy to comprehend the nature of motion of an object. Thereby, the improvement in imaging capability for a dynamic object scene is implemented.

It is noted that in this embodiment, the determination of the sport scene is assumed. However, when the mode of the motion patterns DP_{—}0 to DP_{—}15 is appropriately changed, the present invention can also be applied to adjustment of an imaging parameter of a surveillance camera or a WEB camera.

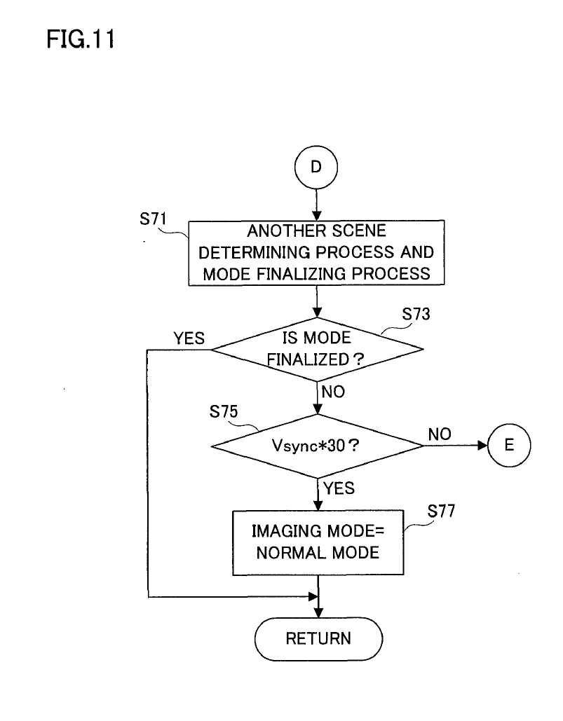

Moreover, this embodiment is so designed that when the scene is not explicitly determined even after an elapse of the 30-frame period from a start of the mode setting process, the imaging mode is finalized to the normal mode (see the steps S75 to S77 in FIG. 11). However, it is possible to promptly finalize the imaging mode to the normal mode when the scene is not explicitly determined.

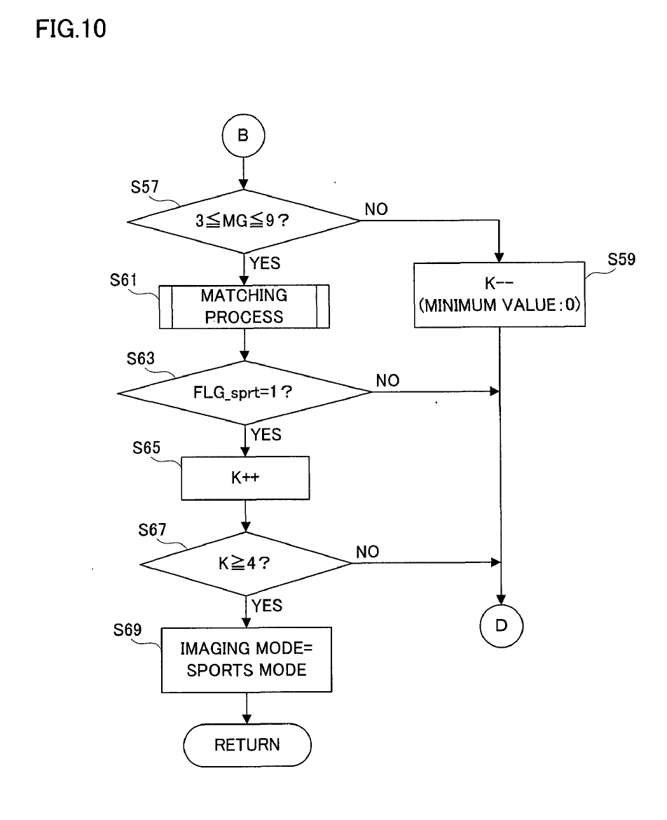

Also, in this embodiment, when the imaging mode is finalized to the sport mode, the mode setting process is ended (see the step S69 in FIG. 10). However, when a priority order is allocated to a plurality of scenes, i.e., a plurality of imaging modes, determined by the mode setting process, it is necessary to execute the another scene determining & mode finalizing process even after the imaging mode is finalized to the sport mode. In this case, it is necessary to proceed to the step S71 after the process in the step S69, and it is further necessary to execute a process for selecting an imaging mode having a higher priority order from among a plurality of finalized imaging modes after YES is determined in the step S73.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface on which an object scene is captured, for repeatedly outputting an object scene image;
a detector for detecting one or more motion areas indicating motion exceeding a reference from among a plurality of areas on the object scene, based on the object scene image outputted from said imager; and
an adjuster for adjusting an imaging parameter by comparing a pattern of the one or more motion areas detected by said detector with a predetermined area pattern.

2. An electronic camera according to claim 1, wherein each of the plurality of areas has a plurality of small areas, and said detector includes a motion coefficient calculator for calculating a plurality of motion coefficients respectively corresponding to he plurality of small areas, an extractor for extracting a motion coefficient exceeding a reference value from among the plurality of motion coefficients calculated by said motion coefficient calculator, and a specifier for specifying, as the motion area, an area to which the small area corresponding to the motion coefficient extracted by the extractor belongs.

3. An electronic camera according to claim 1, wherein said detector repeatedly executes a detecting process, and said adjuster includes a creator for repeatedly creating a pattern of the one of more motion areas and a setter for setting the imaging parameter to a predetermined parameter in reference to a number of times that satisfies a predetermined condition between the pattern created by said creator and the predetermined area pattern.

4. An electronic camera according to claim 3, wherein the predetermined condition includes a condition under which the predetermined area pattern involves the pattern created by the creator

5. An electronic camera according to claim 1, wherein the imaging parameter adjusted by said adjuster is equivalent to an imaging parameter that matches a sport scene.

6. An imaging controlling program product executed by a processor of an electronic camera provided with an imager, having an imaging surface on which an object scene is captured, for repeatedly outputting an object scene image, said imaging controlling program product, comprising:
a detecting step of detecting a motion area indicating motion exceeding a reference from among a plurality of areas on the object scene, based on the object scene image outputted from said imager; and
an adjusting step of adjusting an imaging parameter by comparing a pattern for the motion area detected by said detecting step with a predetermined area pattern.

7. An imaging controlling method executed by an electronic camera provided with an imager, having an imaging surface on which an object scene is captured, for repeatedly outputting an object scene image, said imaging controlling method, comprising:
a detecting step of detecting one or more motion areas indicating motion exceeding a reference from among a plurality of areas on the object scene, based on the object scene image outputted from said imager; and
an adjusting step of adjusting an imaging parameter by comparing a pattern of the one or more motion areas detected by said detecting step with a predetermined area pattern.
